(19) United States
(12) Patent Application Publication
(10) Pub. No.: US 2008/0083092 A1
(43) Pub. Date: Apr. 10, 2008

(54) Lever handle and fabricating method thereof

(75) Inventors: Lien-Hsi Huang, Kaohsiung City (TW); Kuang-Chun Chiang, Ziguan Shiang (TW)

Correspondence Address: TROXELL LAW OFFICE PLLC, Suite 1404, 5205 Leesburg Pike, Falls Church, VA, 22041, US

(73) Assignee: Taiwan Fu Hsing Industrial Co., Ltd.

(21) Appl. No.: 11/544,034

(22) Filed: Oct. 6, 2006

(51) Int. Cl. E05B 1/00

(52) U.S. Cl. 16/436

(57) ABSTRACT

A lever handle comprises a handle, a hollow sleeve and a cover. The handle has a casing portion and a cylinder formed at one end of the casing portion. The cylinder has an extending protrusion. The hollow sleeve that is installed within the cylinder of the handle has a shaft tube, an extending tube and at least one inward protrusion. The extending tube is formed at one side of the shaft tube and engages with the extending protrusion of the cylinder. The cover is coupled to the casing portion of the handle so as to limit the hollow sleeve.

### FIELD OF THE INVENTION

The present invention relates to a lever handle, more particularly to a lever handle and fabricating method thereof, in which a hollow sleeve is fixedly installed within a cylinder of a handle.

### BACKGROUND OF THE INVENTION

Because conventional lever handle fabricated with casting method is concerned on heaviness and high cost, an assembly type hollow handle and fabricating method thereof is disclosed in R.O.C. Patent No. 00,327,911 to improve fabricating difficulty of conventional lever handle. However, the lever hollow handle mentioned above is poor designed so that the rotator member cannot be fixedly connected and driven resulting in disengaging between the handle and the rotator member during a long term usage and then the handle is unable to be used normally.

### SUMMARY OF THE INVENTION

One object of the present invention is to provide a lever handle including a handle, a hollow sleeve and a cover. The handle has a casing portion and a cylinder formed at one end of the casing portion, and the cylinder has an extending protrusion. The hollow sleeve is installed within the cylinder of the handle and has a shaft tube, an extending tube and at least one inward protrusion. The extending tube is formed at one side of the shaft tube and engages with the extending protrusion of the cylinder. The cover is coupled to the casing portion of the handle. In this invention, the hollow sleeve is fixedly installed within the cylinder of the handle that may improve fabricating difficulty, save material cost, prohibit the hollow sleeve disengaging from the handle as well as substantially strengthen the structure strength of the lever handle.

Another object of the present invention is to provide a method of fabricating lever handle, which includes providing a handle that has a casing portion and a cylinder formed at one end of the casing portion, and the cylinder has an extending protrusion. Then, a hollow sleeve that has a shaft tube, an extending tube and at least one inward protrusion is installed within the cylinder of the handle. The extending tube is formed at one side of the shaft tube and engages with the extending protrusion of the cylinder. Next, a cover is coupled to the casing portion of the handle and contacts the hollow sleeve.

A further object of the present invention is to provide a lever handle, wherein the hollow sleeve has at least one reinforcing part and tightly close to the cylinder of the handle by means of the reinforcing part to strengthen entire structure of the lever handle.

Yet another object of the present invention is to provide a lever handle, which further includes a coupling member formed between the outside wall of the hollow sleeve and the cylinder of the handle to serve coupling the hollow sleeve and the handle, thereby improving the coupling strength of the hollow sleeve and the handle.

A lever handle in accordance with the present invention comprises a handle, a hollow sleeve and a cover. The handle has a casing portion and a cylinder formed at one end of the casing portion, and the cylinder has an extending protrusion. The hollow sleeve is installed within the cylinder of the handle and has a shaft tube and an extending tube. The extending tube is formed at one side of the shaft tube and engages with the extending protrusion of the cylinder. The cover is coupled to the casing portion of the handle and contacts the hollow sleeve.

Another lever handle in accordance with the present invention comprises a handle, a hollow sleeve and a cover. The handle has a casing portion and a cylinder formed at one end of the casing portion and having a stop part. The hollow sleeve is installed within the cylinder of the handle and has a limit part being blocked by the stop part. The cover is coupled to the casing portion of the handle and contacts the hollow sleeve.

A method of fabricating lever handle in accordance with the present invention comprises providing a handle that has a casing portion and a cylinder formed at one end of the casing portion, and the cylinder has an extending protrusion. Then, a hollow sleeve that has a shaft tube and an extending tube is installed within the cylinder of the handle. The extending tube is formed at one side of the shaft tube and engages with the extending protrusion of the cylinder. Next, a cover is coupled to the casing portion of the handle and contacts the hollow sleeve.

### DESCRIPTION OF THE DRAWINGS

FIG. 1A to FIG. 1C are perspective view illustrating process of fabricating a lever handle in accordance with a preferred embodiment of the present invention.

FIG. 2 is a top plan view illustrating a lever handle in accordance with a preferred embodiment of the present invention.

FIG. 3A is a cross-sectional view illustrating a handle in accordance with a preferred embodiment of the present invention.

FIG. 3B is a cross-sectional view illustrating which a hollow sleeve is installed within a handle in accordance with a preferred embodiment of the present invention.

FIG. 3C is a cross-sectional view taken along line 3C-3C of FIG. 2 illustrating which a cover is coupled to a handle.

FIG. 4 is a cross-sectional view illustrating which a coupling member is formed in accordance with a preferred embodiment of the present invention.

FIG. 5 is a perspective view illustrating which a hollow sleeve forms a reinforcing part and a second flange in accordance with another embodiment of the present invention.

FIG. 6 is a cross-sectional view illustrating which a hollow sleeve is installed within a handle in accordance with another embodiment of the present invention.

FIG. 7 is a cross-sectional view illustrating which a cover is coupled to a handle in accordance with another embodiment of the present invention.

### DETAILED DESCRIPTION OF THE INVENTION

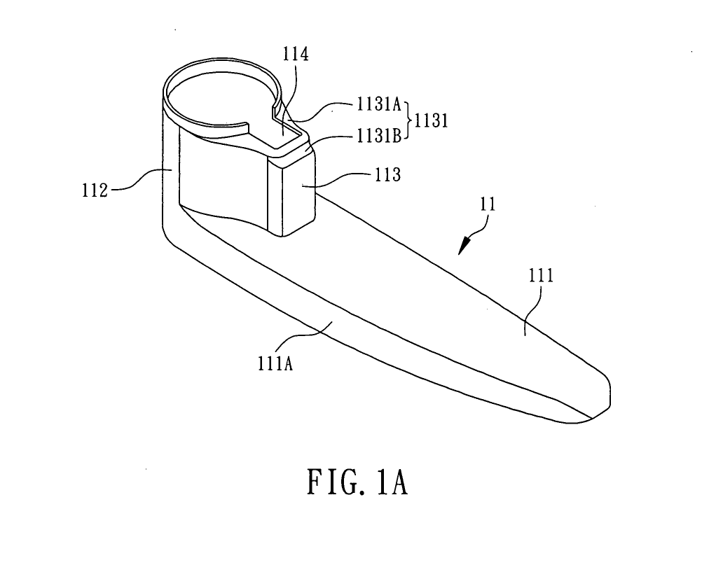

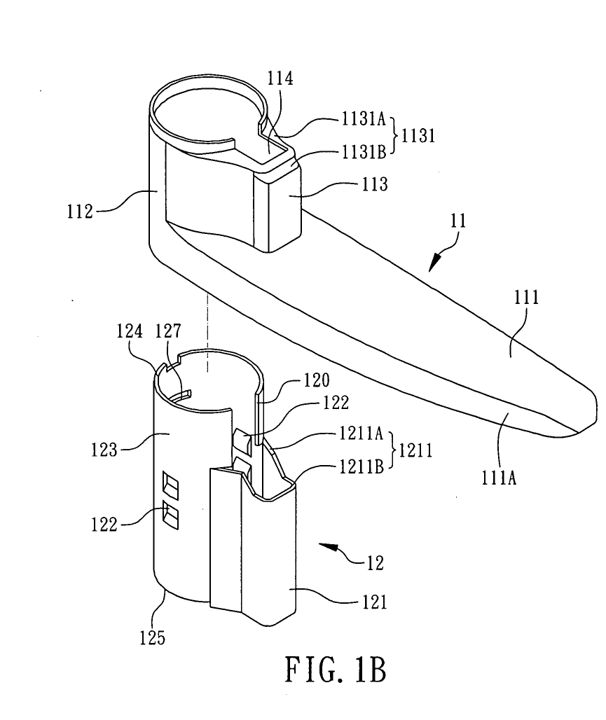

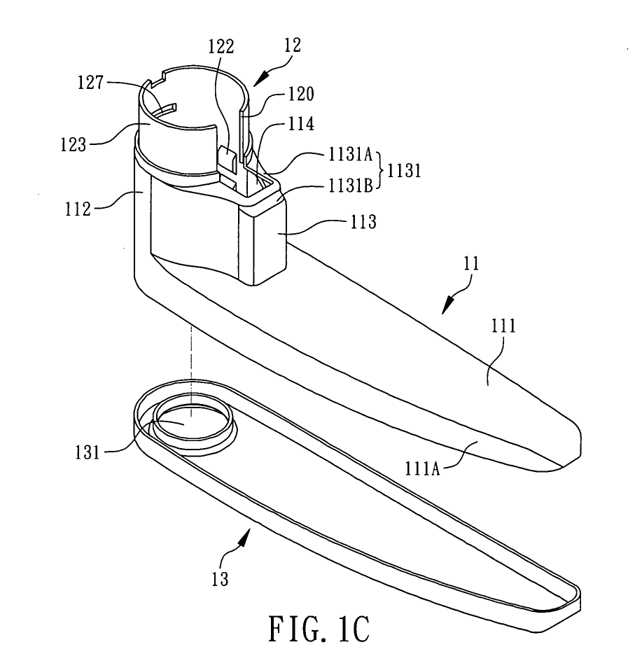

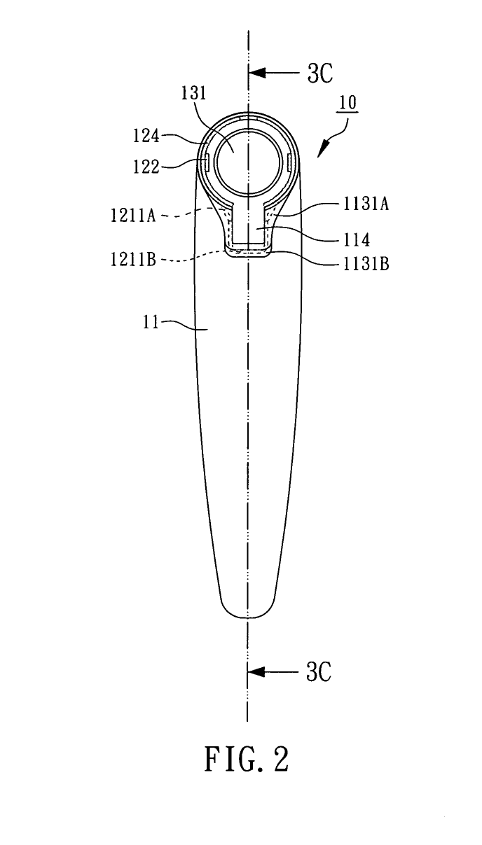

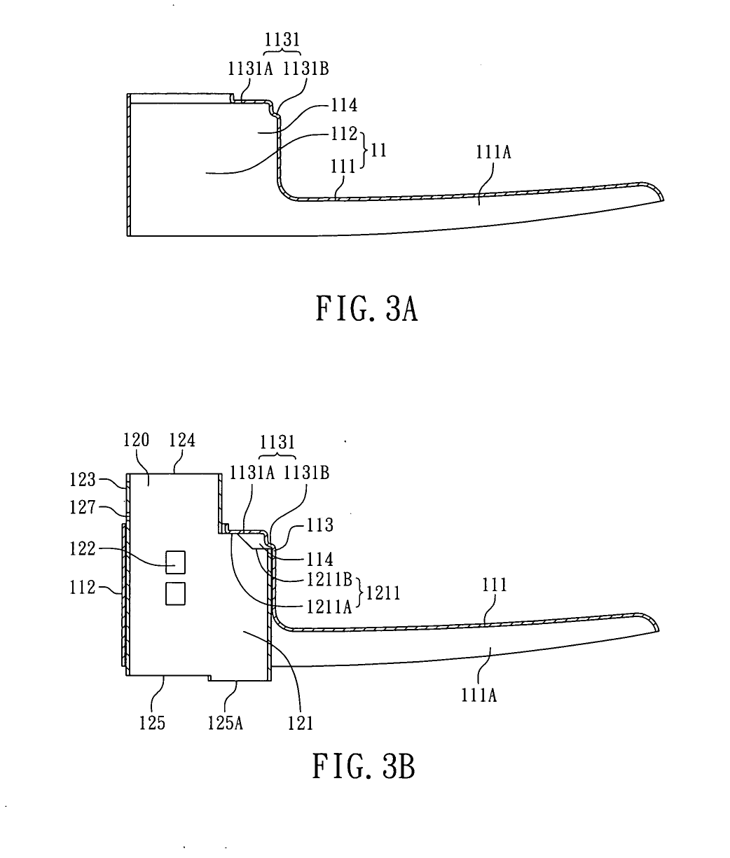

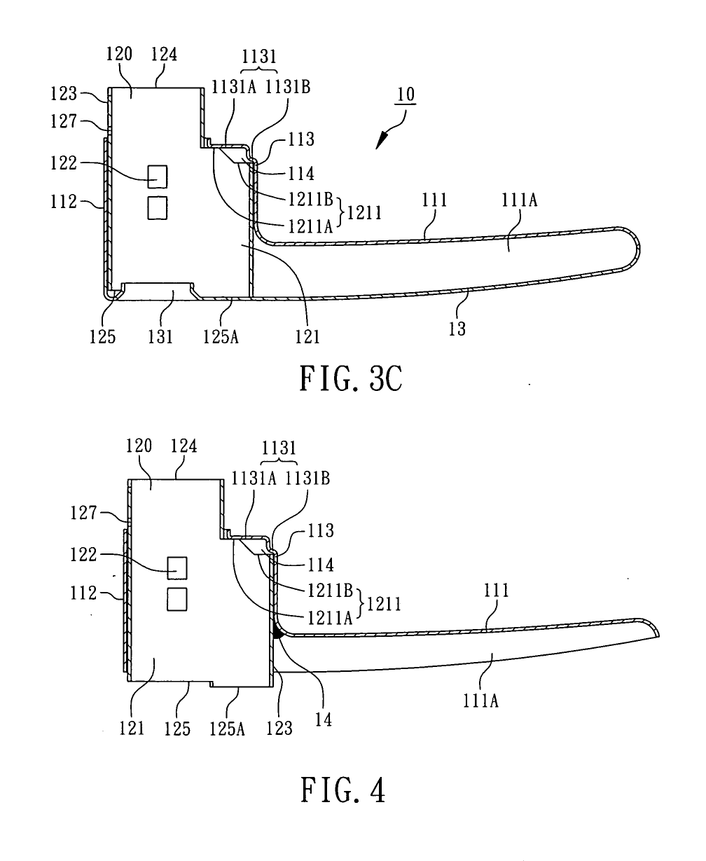

FIG. 1A to FIG. 1C, FIG. 2 and FIG. 3A to FIG. 3C show a method of fabricating a lever handle 10 according to a preferred embodiment of the present invention. First referring to FIG. 1A and FIG. 1C, a handle 11 having a casing portion 111 and a cylinder 112 integrally formed at one end of the casing portion 111 is provided. The cylinder 112 is desirable to be formed by extending from one end of the casing portion 111. The cylinder 112 has an extending protrusion 113 having a chamber 114 formed inside thereof. In this embodiment, the extending protrusion 113 has a stop part 1131 formed as a step-like shape, and the stop part 1131 has a first stop part 1131A and a second stop part 1131B beneath the first stop part 1131A. The handle 11 is also preferably formed by stamping a metal plate (not showed in the drawings). Then referring to FIG. 1B and FIG. 3B, a hollow sleeve 12 is installed within the cylinder 112 of the handle 11 and is formed by stamping and rounding a metal plate. The hollow sleeve 12 has a shaft tube 120, an extending tube 121 formed at one side of the shaft tube 120, at least one inward protrusion 122 and an outside wall 123. The extending tube 121 is received within the chamber 114 of the extending protrusion 113 and engages with the extending protrusion 113 of the cylinder 112. The extending tube 121 further has a limit part 1211 being blocked by the stop part 1131 of the extending protrusion 113. The inward protrusion 122 is formed on the outside wall 123, and the inward protrusion 122 showing a dent and a bulge at its outside and inside respectively may be in geometric shapes such as strip shape or bulgy shape and is preferably formed at the same time of forming the hollow sleeve 12 with stamping method. The inward protrusion 122 is utilized for connecting and driving an inner spindle (not showed in the drawings) to rotate, while the inner spindle rotated, a latch of a lock can be driven to move out and in. The limit part 1211 has a first limit part 1211A and a second limit part 1211B. In this embodiment, while the hollow sleeve 12 is installed within the cylinder 112 of the handle 11, the first limit part 1211A is blocked by the first stop part 1131A of the stop part 1131 and the second limit part 1211B is blocked by the second stop part 1131B of the stop part 1131. The extending tube 121 of the hollow sleeve 12 engages with the extending protrusion 113 of the cylinder 112 and the limit part 1211 of the extending tube 121 is blocked by the stop part 1131 of the extending protrusion 113, so that the hollow sleeve 12 can be fixedly limited in the cylinder 112 of the handle 11 and also driven by the handle 11. Moreover, in another embodiment, while the hollow sleeve 12 is installed within the cylinder 112 of the handle 11, either the first limit part 1211A is only blocked by the first stop part 1131A of the stop part 1131 or the second limit part 1211B is only blocked by the second stop part 1131B of the stop part 1131 may also allow the hollow sleeve 12 to be fixedly limited in the cylinder 112 and driven by the handle 11. Finally referring to FIGS. 1C and 3C, a cover 13 is coupled to the casing portion 111 of the handle 11 so as to limit the hollow sleeve 12. The cover 13 formed by stamping a metal plate (not showed in the drawings) contacts the hollow sleeve 12. The casing portion 111 may have a ring wall 111A. In this embodiment, the cover 13 has an opening 131 corresponding to the cylinder 112 of the handle 11 to accommodate lock device, knob or push-button and may be coupled to the ring wall 111A of the casing portion 111 by applying soldering, attaching or engaging method.

Referring now to FIGS. 3B and 3C, in this embodiment, the hollow sleeve 12 has a top 124 and a bottom 125 corresponding to the top 124 and the limit part 1211. The bottom 125 has a first flange 125A corresponding to the limit part 1211. While the cover 13 is coupled to the casing portion 111 of the handle 11, it contacts the first flange 125A of the bottom 125 to enable the hollow sleeve 12 to be fixedly installed within the cylinder 112 of the handle 11. Referring FIG. 4, in order to fixedly couple the hollow sleeve 12 to the handle 11, there further is a coupling member 14 formed between the outside wall 123 of the hollow sleeve 12 and the cylinder 112 of the handle 11 to couple the hollow sleeve 12 to the cylinder 112 of the handle 11. In this embodiment, the coupling member 14 can be a solder material or an adhesive and preferably couples the hollow sleeve 12 to the cylinder 112 of the handle 11 by soldering method, such as spot soldering or full circle soldering method.

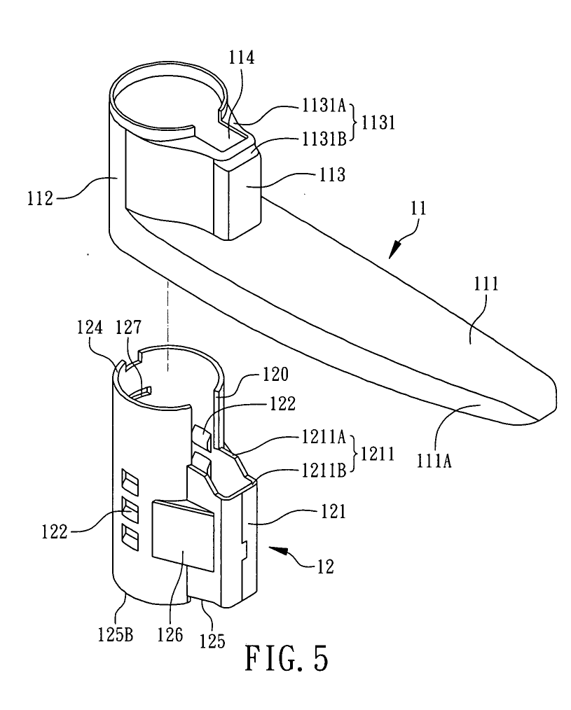

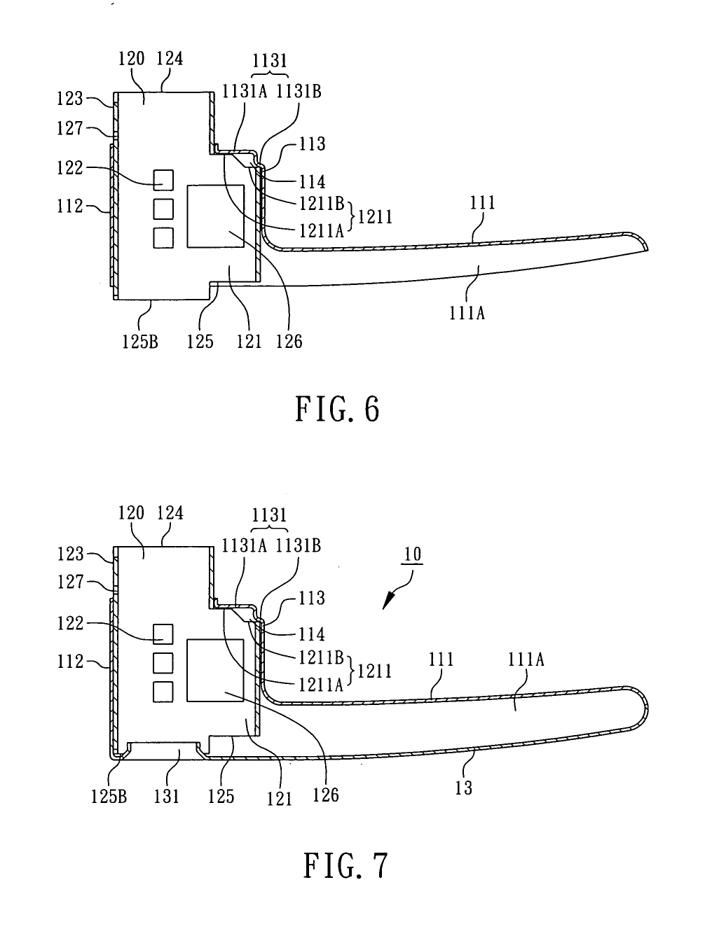

In another embodiment as showed in FIGS. 5, 6 and 7, the hollow sleeve 12 may further has at least one reinforcing part 126 formed on the outside wall 123 of the hollow sleeve 12 and the reinforcing part 126 showing a dent and a bulge at its outside and inside respectively may preferably be formed while forming the hollow sleeve 12 by stamping method. The hollow sleeve 12 tightly closes to the cylinder 112 of the handle 11 by means of the reinforcing part 126 to strengthen entire structure of the lever handle 10. Besides, in this embodiment, the bottom 125 further has a second flange 125B corresponding to the top 124. While the cover is coupled to the casing portion 111 of the handle 11, it may contact the second flange 125B of the bottom 125 that enables the hollow sleeve 12 to be fixedly installed within the cylinder 112 of the handle 11. In this embodiment as showed in FIG. 1B or 5, the hollow sleeve 12 further has a catch hole 127 to engage with a bump (not showed in the drawings) of the inner spindle so as to drive the inner spindle to rotate.

Referring now to FIG. 3C, a lever handle 10 in accordance with the present invention comprises a handle 11, a hollow sleeve 12 and a cover 13. The handle 11 has a casing portion 111 and a cylinder 112 integrally formed at one end of the casing portion 111. The cylinder 112 has an extending protrusion 113 and the extending protrusion 113 has a stop part 1131. The hollow sleeve 12 installed within the cylinder 112 of the handle 11 has a shaft tube 120, an extending tube 121, at least one inward protrusion 122 and an outside wall 123. The extending tube 121 formed at one side of the shaft tube 120 engages with the extending protrusion 113 of the cylinder 112. The extending tube 121 has a limit part 1211 being blocked by the stop part 1131 of the extending protrusion 113. The cover 13 is coupled to the casing portion 111 of the handle 11 and contacts the hollow sleeve 12 so as to limit the hollow sleeve 12. In this embodiment, the hollow sleeve has a top 124 and a bottom 125 corresponding to the top 124 and the limit part 1211. The bottom 125 has a first flange 125A corresponding to the limit part 1211. Otherwise, in another embodiment as showed in FIG. 7, the bottom 125 has a second flange 125B corresponding to the top 124. While the cover 13 is coupled to the casing portion 111 of the handle 11, it may contact the first flange 125A or the second flange 125B of the bottom 125 thereby allowing the hollow sleeve 12 to be fixedly installed within the cylinder 112 of the handle 11. Moreover, referring now to FIG. 7, the hollow sleeve 12 may further have at least one reinforcing part 126 formed on the outside wall 123 thereof. The hollow sleeve 12 can tightly close to the cylinder 112 of the handle 11 via the reinforcing part 126, thereby strengthening entire structure of the lever handle 10. Referring now to FIG. 4, in this embodiment, it further has a coupling member 14 formed between the outside wall 123 of the hollow sleeve 12 and the cylinder 112 of the handle 11 to serve coupling the hollow sleeve 12 and the handle 11, thereby improving coupling strength of the hollow sleeve 12 and the handle 11.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A lever handle comprising:
a handle having a casing portion and a cylinder integrally formed at one end of the casing portion, the cylinder having an extending protrusion having a chamber formed inside thereof;
a hollow sleeve installed within the cylinder of the handle, the hollow sleeve having a shaft tube and an extending tube formed at one side of the shaft tube, the extending tube being received within the chamber of the extending protrusion and engaging with the extending protrusion; and
a cover coupled to the casing portion of the handle so as to limit the hollow sleeve.

2. The lever handle in accordance with claim 1, wherein the extending protrusion has a stop part, and the extending tube has a limit part being blocked by the stop part of the extending protrusion.

3. The lever handle in accordance with claim 2, wherein the stop part of the extending protrusion has a first stop part and a second stop part, the limit part of the extending tube has a first limit part being blocked by the first stop part and a second limit part being blocked by the second stop part.

4. The lever handle in accordance with claim 1, wherein the cover contacts the hollow sleeve.

5. The lever handle in accordance with claim 1, wherein the hollow sleeve has an outside wall and at least one reinforcing part formed on the outside wall.

6. The lever handle in accordance with claim 1, wherein the hollow sleeve has an outside wall and at least one inward protrusion formed on the outside wall.

7. A lever handle comprising:
a handle having a casing portion and a cylinder integrally formed at one end of the casing portion, the cylinder having a stop part;
a hollow sleeve installed within the cylinder of the handle, the hollow sleeve has a limit part being blocked by the stop part of the cylinder; and
a cover coupled to the casing portion of the handle so as to limit the hollow sleeve.

8. The lever handle in accordance with claim 7, wherein the stop part of the cylinder has a first stop part and a second stop part, the limit part of the hollow sleeve has a first limit part being blocked by the first stop part and a second limit part being blocked by the second stop part.

9. The lever handle in accordance with claim 7, wherein the cover contacts the hollow sleeve.

10. The lever handle in accordance with claim 7, wherein the hollow sleeve has an outside wall and at least one reinforcing part formed on the outside wall.

11. The lever handle in accordance with claim 7, wherein the hollow sleeve has an outside wall and at least one inward protrusion formed on the outside wall.

12. The lever handle in accordance with claim 7, wherein the hollow sleeve is coupled to the handle.
